(19) United States
(12) Patent Application Publication
(10) Pub. No.: US 2022/0198319 A1
(43) Pub. Date: Jun. 23, 2022

(54) Machine Learning Feature Stability Alerts

(71) Applicant: Bottomline Technologies, Inc., Portsmouth, NH (US)

(72) Inventors: Priya Singh, Portsmouth, NH (US); Shantanu Lodh, Reading (GB); Cole Brendel, Somerville, MA (US)

(73) Assignee: Bottomline Technologies, Inc., Portsmouth, NH (US)

(21) Appl. No.: 17/126,739

(22) Filed: Dec. 18, 2020

(51) Int. Cl. G06N 20/00

(52) U.S. Cl. CPC G06N 20/00; G06F 17/18

(57) ABSTRACT

A method for creating machine learning model performance alerts showing the drifting of functions is described herein. The method starts by creating the initial machine learning model using a training data set. This initial machine learning model is then used in production, and the model is updated to account for the production data. To assure the quality of the updated machine learning model, test data results from the initial machine learning model is compared to the results from the updated machine learning model. Each feature is checked to see if the difference is within a p-value and whether the confidence intervals overlap. If not, an alert is generated to take action on the model.

### PRIOR APPLICATION

This application is a priority application.

### BACKGROUND

### Technical Field

The present inventions relate to machine learning and artificial intelligence and, more particularly, to a method and system for detecting machine learning instability.

### Description of the Related Art

Paymode-X is a cloud-based, invoice-to-pay service that optimizes the accounts payable process. An accounts payable department retains the invoice-to-pay service to handle payments. Each vendor signs up for the service, and invoices are received, processed, approved, and paid through the invoice-to-pay service. The invoice-to-pay service relies on the integrity of the vendor database, and preventing fraudulent payments is important. To prevent fraud, vendors must be vetted to prevent malicious actors. Vendors are vetted using machine learning algorithms.

In the long-running use of a machine learning algorithm, the distribution of various features used in the machine learning model can drift over time. For instance, a model that checked vendor addresses to see if the address were for a residential address may not take into account working from home. The relevance of working at home dramatically changed in 2020 with the COVID pandemic, as vendor's account receivable clerks started working from home. The relevance of residential addresses changed in 2020 and its influence on the model needs to be reassessed. Current machine learning models do not check changes in the relevance of features on the model. An improvement to machine learning models is needed to identify drifting features in a model, and to alert users of the changes in the model. The present inventions provide the improvement.

In an alternate scenario, a monitoring tool in a medical facility that watches for improper access to medical records may flag an access to medical records from a residential IP address. In the past, the machine learning model determined that residential IP addresses were outside of the medical facility and likely improper. But with the rapid increase in telemedicine in 2020, the machine learning model needs to shift dramatically to account for doctors working from home. Similarly, the GPS location where a pharmaceutical prescription is written, and its relevance to a drug monitoring machine learning model has changed in response to the COVID pandemic. The location of the IP (or GPS) address feature and its influence on the machine learning model needs to be reassessed. Current machine learning models do not check changes in the relevance of features on the model. An improvement to machine learning models is needed to identify drifting features in a model, and to alert users of the changes in the model. The present inventions provide the improvement.

### SUMMARY OF THE INVENTIONS

An improved machine learning method is described herein. The method comprises (1) creating a first machine learning model with training data, (2) periodically adjusting the first machine learning model with production data to create a second machine learning model, (3) creating a training dataset by processing the training data through the first machine learning model, (4) creating a prediction dataset by processing the production data set through the second machine learning model, and (5) looping through each feature in the prediction dataset, (5a) determining a p-value by comparing the feature in the prediction dataset to the feature in the training dataset, and (5b) if the p-value is less than a constant (alpha) and a confidence interval for the training dataset does not overlap the confidence interval for the prediction dataset, creating an alert.

In some embodiments, the improved machine learning method further comprises performing a T-test to determine the p-value. In some embodiments, the improved machine learning method further comprises performing a binomial proportions test to determine the p-value. In some embodiments, the improved machine learning method further comprises automatically adjusting the first or second machine learning model based on the alert. In some embodiments, the improved machine learning method further comprises creating a plot of the feature in the prediction dataset. The first machine learning model could be created using a Densicube algorithm, a K-means algorithm, or a Random Forest algorithm. The overlap in the confidence interval could use a mean and a margin of error.

A method for creating machine learning model performance alerts is also described here. The method includes (1) creating a first machine learning model with training data, (2) adjusting the first machine learning model with production data to create a second machine learning model, (3) creating a training dataset by processing the training data through the first machine learning model, (4) creating a prediction dataset by processing the production data through the second machine learning model, and (5) looping through each feature in the prediction dataset, (5a) determining a p-value by comparing the feature in the prediction dataset to the feature in the training dataset, and (5b) if the p-value is less than a constant (alpha) and a confidence interval for the training dataset does not overlap the confidence interval for the prediction dataset, creating the machine learning model performance alert.

### BRIEF DESCRIPTION OF THE DRAWINGS

FIG. 1 is a flowchart of an operating machine learning model with monitoring.

FIG. 2 is a flowchart of the monitoring of a machine learning model.

FIG. 3 is a flowchart of the splitting of outcome dataframes into parts that are analyzed.

FIG. 4 is a flowchart of the calculation of the performances of dataframe parts.

FIG. 5 is a flowchart of the organizing of the feature alerts.

FIG. 6 is an example of a features dataframe.

### DETAILED DESCRIPTION

The present inventions are now described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

It should be appreciated that many of the elements discussed in this specification may be implemented in a hardware circuit(s), a processor executing software code or instructions which are encoded within computer-readable media accessible to the processor or a combination of a hardware circuit(s) and a processor or control block of an integrated circuit executing machine-readable code encoded within a computer-readable media. As such, the term circuit, module, server, application, or other equivalent description of an element as used throughout this specification is, unless otherwise indicated, intended to encompass a hardware circuit (whether discrete elements or an integrated circuit block), a processor or control block executing code encoded in a computer-readable media, or a combination of a hardware circuit(s) and a processor and/or control block executing such code.

The document describes the building of a framework that can be used to monitor the model performance over time. Visualizations are created to see the distribution of model performance over time. Model performance is monitored by evaluating how well is the model fitting the test data. The test dataset is part of the train-validation-test split created when building the model, we can evaluate how well is the model fitting the test set over time using different performance metrics and see the distribution of performance over time using the visualizations.

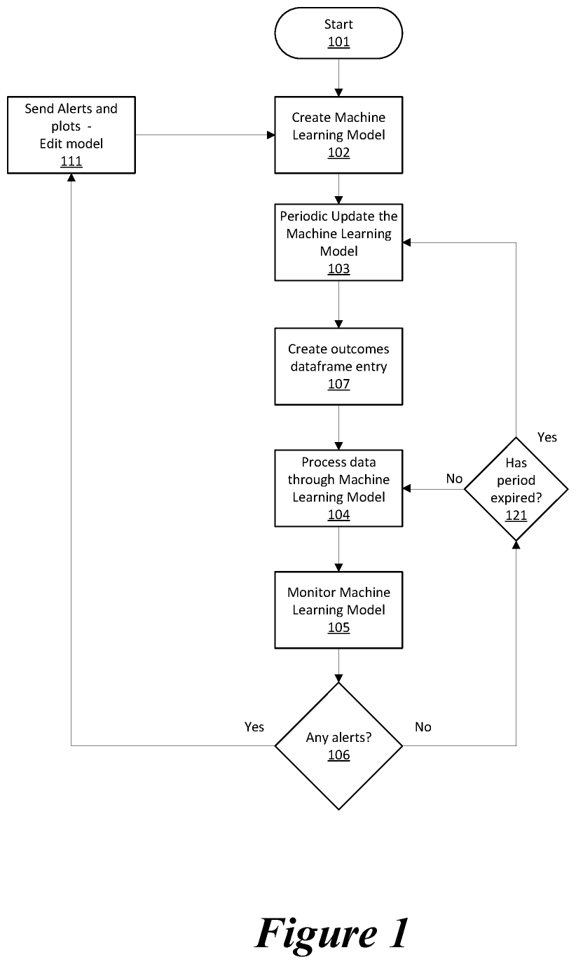

FIG. 1 shows a flow chart of the creation, processing, monitoring, and alerting of a machine learning model. The data scientists work on creating the machine learning model 102 by experimenting between different machine learning models and feature engineering. This model is optimized based on the relationship between the features at the time of model development. The model is periodically regenerated 103 using new data in production. Whenever the model is used in production 104 to process data to generate scores, we need to perform model monitoring 105. As long as the model is being used it needs to be monitored. The model monitoring framework is run and returns alerts 111 if any and the plots for the distribution of the performance metric over time and the distribution of features over time. These alerts and plots are then sent automatically through email to the data scientist. If there are no alerts, we can continue using the model to process data through the machine learning model.

The process starts 101 with the creation of the machine learning model 102. The machine learning model could be created 102 using any number of machine learning algorithms, such as Random Forest, K-Means, Densicube (see U.S. Pat. No. 9,489,627 by Jerzy Bala and U.S. patent application Ser. No. 16/355,985 by Jerzy Bala and Paul Green, both incorporated herein in their entirety by reference), et al. The machine learning algorithms are trained using training data to create the machine learning model 102.

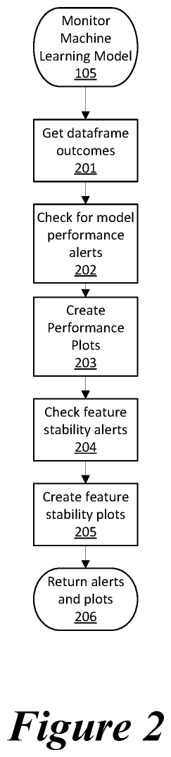

Periodically, the machine learning model is updated 103 using the new data saved from running the machine learning model 104. When the machine learning model is updated 103, an outcomes dataframe entry is added 107 to the outcomes dataframe (see Table 1). The updated machine learning model is then used to process production data through the machine learning model 104. After running the data through the model 104, the machine learning model is monitored 105 to see if the features have drifted over time from the model created by the training data set. The details of this monitoring are described in FIG. 2. While some drift is expected, a substantial change in the importance of various features requires alerting 106 the data scientists. If an alert from the monitoring 105 is reported 106, then the alert is sent 111 to the data scientists along with plots of the distribution of features and performance over time. The data scientists, now alerted, can review the alerts and plots to see if the model needs to be updated. In some embodiments, an intelligent model adjustment algorithm is run to modify the model and/or the training data set automatically to address the alert.

If there are no alerts 106, the period is checked 121 to see if it is time to update the model 103. If so, the model is updated 103. If not, the next set of production data is processed through the machine learning model 104. The period could be a count of the number of transactions processed (every ten, hundred, or thousand transactions) or it could be a set time (every day at midnight, every week, monthly, etc).

Next, we look to FIG. 2. The process of monitoring machine learning model 105 has two main parts: monitor model performance and monitor feature stability. To monitor model performance two steps are taken: creating performance plots 203 and check for performance alerts 202. To monitor feature stability two steps are taken: creating feature stability plots 205 and check for feature stability alerts 204.

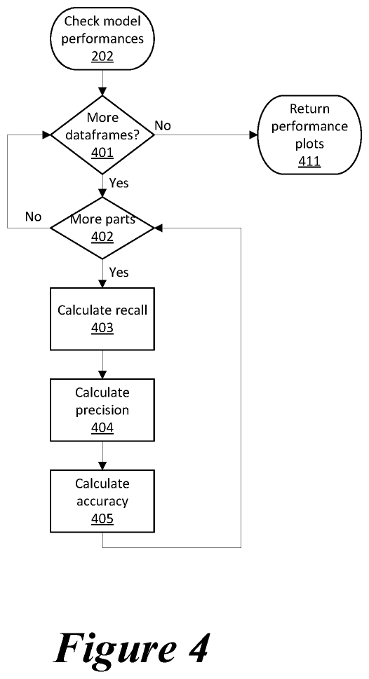

Specifically, the monitor machine model 105 routine starts by obtaining the dataframe outcomes 201. The outcome dataframe is created 107 for every time the model is used to trained and the performance on the test set is known. The outcome dataframe is the test set from the train-validation-test split made while training the model. The outcome dataframe has a unique identifier for each observation, score generated by the model, actual outcome, predicted outcome. With the dataframe outcomes, the model is checked for permance alerts 202. The evaluation of the model for performance alerts is further enumerated in FIG. 4. Next, the performance plots are created 203. The performance dataframe is read and used as data to create the plots. Distribution of precision, recall, and accuracy over time is visualized. A confidence interval of 95% is generally used in the plots but the confidence interval is a configurable parameter that can be changed.

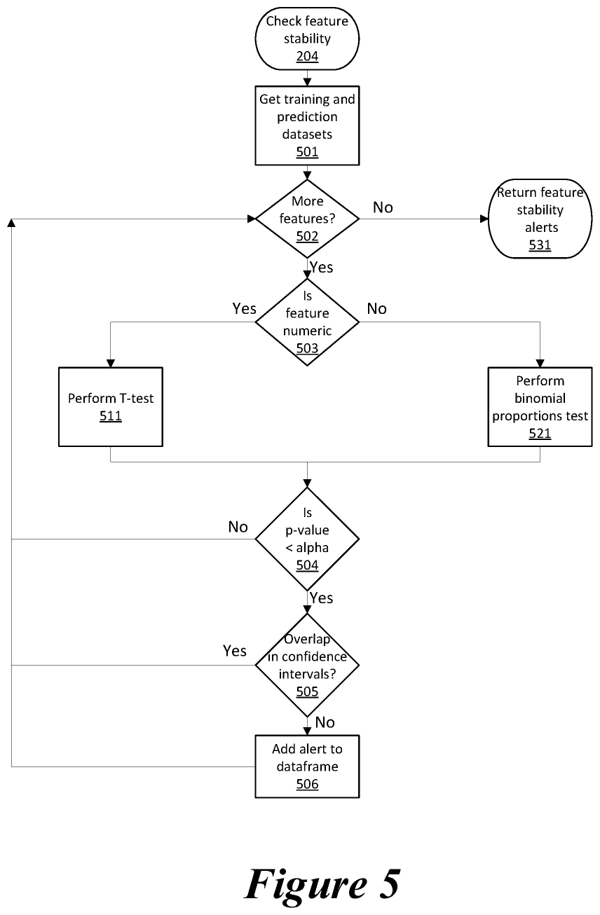

Next, the feature stability alerts are created 204. These feature stability alerts 204 are further described in FIG. 5. Once the feature stability alerts 204 are created, the feature stability plots are created 205. The feature stability dataframe 601 is read and used to create the plots of the values of the feature fields 612, 613, 614, 615, 616, 617, 618. There is an option to have plots of individual features or plots of a group of features together, which can be specified in the config file. The groups of the features are provided in a yaml file. A confidence interval of 95% is generally used in the plots but the confidence interval is a configurable parameter that can be changed. The alerts and plots are then returned 206.

Using the outcome dataframe, different performance metrics are calculated like precision, recall, and accuracy. These performance metrics have a set threshold in the monitor config file. Then the model monitoring framework would check for model performance and feature stability alerts. Also, it would create performance and feature stability plots. The alerts and plots are then returned to the data scientist by email whenever the model is used to process data.

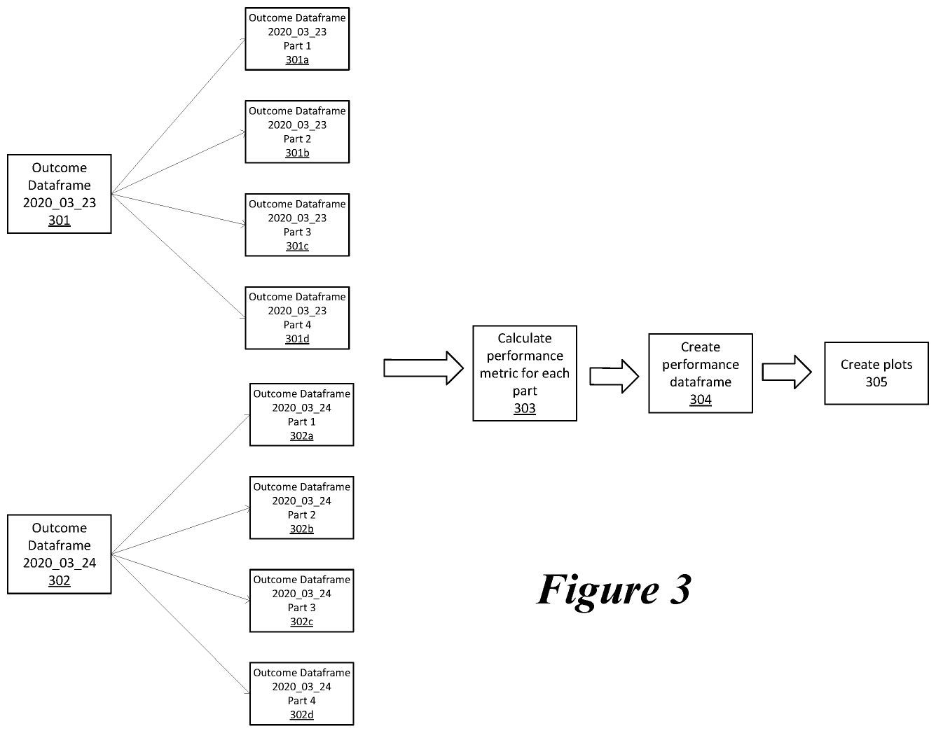

FIGS. 3 and 4 explain the process of creating performance plots. Monitoring model performance to evaluate how well is the model fitting the test data. The test dataset is part of the train-validation-test split, we can evaluate how well is the model fitting the test set over time using different performance metrics and see the distribution of performance over time. The outcome dataframe is created 107 for every time the model is used to train and the performance on the test set is known. The outcomes dataframe has four columns: the date at which the model was trained, the probability score, the actual Y (ground truth), and the predicted Y (predicted class by the model).

TABLE 1
Outcomes Dataframe

| Date | Probability | Actual Y | Predicted Y |
|---|---|---|---|
| 20201130 | 0.1786627 | 1 | 0 |
| 20201201 | 0.0542814 | 1 | 0 |
| 20201202 | 0.122940 | 0 | 0 |
| 20201203 | 0.671590 | 1 | 1 |
| 20201204 | 0.3391538 | 1 | 0 |

Divide every outcome file 301, 302 into 4-5 parts 301a, 301b, 301c, 301d, 302a, 302b, 302c, 302d randomly to get a confidence interval estimate 303 which can be controlled using a parameter in the config file. Calculate the performance metrics for each of the parts 301a-d, 302a-d like precision, recall, and accuracy. The performance metric values for all the parts 301a-d, 302a-d of the outcome dataframes are stored in the performance dataframe 304. The performance dataframe has seven columns: the date of the outcome file, the part number, precision_0 of class 0 for the part, precision_1 of class 1 for the part, recall_0 of class 0 for the part, recall_1 of class 1 for the part, and the accuracy for the part.

TABLE 2
Performance Dataframe

| | | | | | | Accur- |
|---|---|---|---|---|---|---|
| Date | Part | Precision_0 | Precision_1 | Recall_0 | Recall_1 | acy |
| 20201130 | 1 | 0.79 | 0.36 | 0.67 | 0.52 | 0.63 |
| 20201201 | 2 | 0.67 | 0.42 | 0.64 | 0.45 | 0.58 |
| 20201202 | 3 | 0.68 | 0.43 | 0.63 | 0.47 | 0.58 |
| 20201203 | 1 | 0.73 | 0.36 | 0.60 | 0.51 | 0.57 |
| 20201204 | 2 | 0.70 | 0.44 | 0.64 | 0.51 | 0.59 |
| 20201205 | 3 | 0.74 | 0.39 | 0.68 | 0.47 | 0.62 |

The performance dataframe is read and used as data to create the plots 305. The distribution of precision, recall, and accuracy over time is visualized. A confidence interval of 95% is generally used in the plots but the confidence interval is a configurable parameter that can be changed. The performance plots are returned.

Looking at FIG. 4, the performance models are checked 202. This starts by looping through all dataframes 401 and looping through all parts 402. When all of the parts 402 have been examined, the next dataframe is examined. When all dataframes 401 have been examined, the performance alerts and plots are returned 411.

For each part of each dataframe, calculate the recall 403, the precision 404, and the accuracy 405. Accuracy is calculated 405 as:

$$accuracy = \frac{true predictions}{total predictions} = \frac{true positives + correct negatives}{\begin{matrix}true poistives + false positives + \\ true negatives + false negatives\end{matrix}} \\ Precision is calculated 404 as : \\ precision = \frac{true positive}{total positive} = \frac{true positive}{true positive + false positive}$$

Precision_1 is the precision for positives and precision_0 is the precision for the negatives (i.e. use true negative and false negative in place of the positive values).

Recall is calculated 403 as:

$$recall = \frac{true positive}{predicted results} = \frac{true positive}{true positive + false negative}$$

Recall_1 is the precision for positives and recall_0 is the precision for the negatives (i.e. use true negative in place of the true positive and false positive instead of false negative).

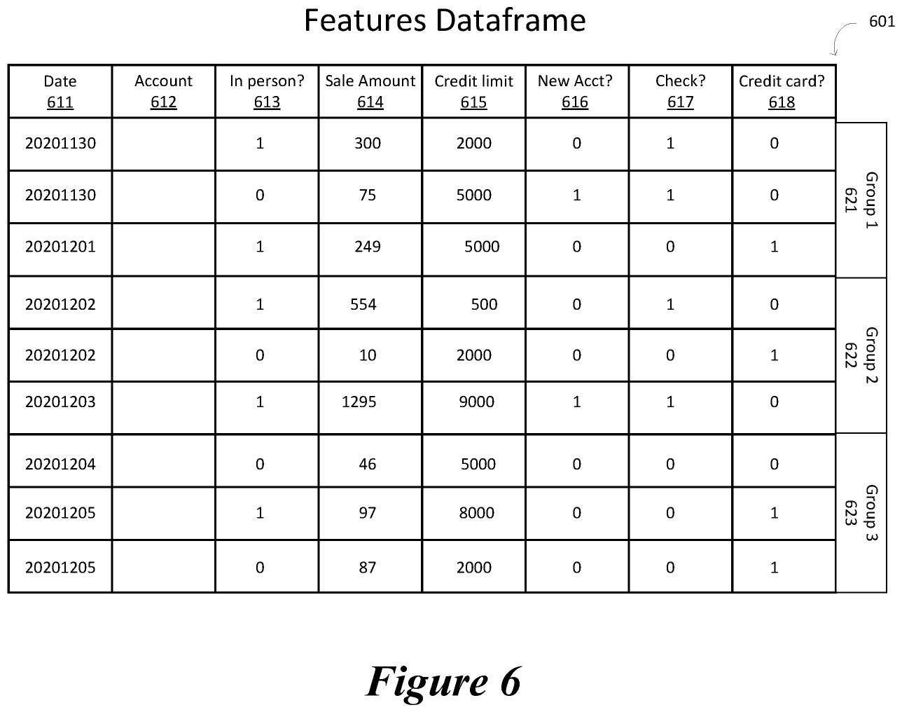

FIG. 5 explains the process of generating feature stability alerts. Get the pre-processed training and the prediction dataset 501. FIG. 6 shows a sample feature dataframe 601 with a date field 611 and seven features 612, 613, 614, 615, 616, 617, 618 that is split into three parts 621, 622, 623. The date 611 field has the date when the model was used to score. The features 612, 613, 614, 615, 616, 617, 618 value is the value of the features for the observations on the date the model was scored.

For each feature 502, check if the raw feature was numeric (614, 615) or categorical (613, 617, 618, 619) 503. If numeric then perform a T-test 511 with the null hypothesis that the distribution of the feature in the training dataset is the same as the distribution of the feature in the prediction dataset. If the feature is categorical, then perform a binomial proportion test 521 with the null hypothesis that the proportion of the feature in the training dataset is the same as the proportion of the feature in the prediction dataset. Both these statistical tests return a p-value. The alpha (a constant representing a significance level) which is the probability of rejecting the null hypothesis when it is true (false positive) is configurable for each model. If the p-value is less than or equal to the alpha 504, then we reject the null hypothesis, and we say the result is statistically significant. If the p-value is greater than alpha 504, then we fail to reject the null hypothesis, and we say that the result is statistically nonsignificant. Since we have a large sample size, we can't solely rely on the p-values. So, if the p-value is less than or equal to alpha we check if there is an overlap in the confidence intervals 505 by using the mean and the margin of error (amount of random sampling error for a 95% confidence level) for each distribution for numeric features and expected probability of success and margin of error for proportions for categorical features. If the confidence intervals overlap 505, then there is no need to create an alert else an alert for that feature is created. The feature stability alerts generated 506 are returned 531 and automatically sent to the data scientists through email.

FIG. 5 shows a flowchart of checking feature stability 204. This process begins by obtaining the training and prediction datasets 501. For these datasets, the process loops through every feature 502. When there are no more features 612, 613, 614, 615, 616, 617, 618, the function returns the feature stability alerts 531. If there are multiple entries for a single date, the entries are combined and the mean is entered for the feature.

For each feature 612, 613, 614, 615, 616, 617, 618, the feature is checked to see if it is numeric 503. If the feature is numeric, a T-test is performed 511. The T-test is calculated by subtracting the mean of the test data set for the function from the mean of the prediction data set for the function and dividing by a function of the variances. Note that the Tscore is the p-value.

$$Tscore = \frac{{mean}_{test} - {mean}_{predicted}}{\begin{matrix}\sqrt{\frac{1}{{n}_{test}} + \frac{1}{{n}_{predicted}}} * \\ \frac{( {n}_{test} - 1 ) * {var}_{test}^{2} + ( {n}_{predicted} - 1 ) * {var}_{predicted}^{2}}{{n}_{test} + {n}_{predicted} - 2}\end{matrix}}$$

Where n is the number of samples, var is the variance, and mean is the mean of each data set.

If the feature is not numeric 503, then a binomial proportion test 521 is performed for the categorical features. A random sample of the training dataset is taken to match the number of observations in the prediction dataset. A binomial proportion test is performed with the null hypothesis that the proportion of the feature in the training dataset is the same as the proportion of the feature in the prediction dataset. The alternate hypothesis is that the proportion of the feature in training and prediction dataset significantly differ from each other. The hypothesized probability of success is the proportion of 1 for the feature in the training dataset (probability in the formula below). The binomial proportions test would return the p-value. The alpha (the constant representing the significance level) which is the probability of rejecting the null hypothesis when it is true (false positive) is configurable for each model. If the p-value is less than or equal to the alpha 504, then we reject the null hypothesis, and we say the result is statistically significant. If the p-value is greater than alpha 504, then we fail to reject the null hypothesis, and we say that the result is statistically nonsignificant.

The binomial proportion test is

$$Pvalue = Z = \frac{matches - count * probablity}{\sqrt{count * probability * ( 1 - probability )}}$$

Since we have a large sample size, we can't solely rely on the p-values. So if the p-value is less than or equal to alpha 504 we check if there is an overlap in the confidence intervals 505 by using the mean and the margin of error (amount of random sampling error for a 95% confidence level) for each distribution for numeric features and expected probability of success and margin of error for proportions for categorical features. If the confidence intervals overlap 505 then there is no need to create an alert else an alert for that feature is created 506. Then, the next feature is checked 502.

Although the inventions are shown and described with respect to certain exemplary embodiments, it is obvious that equivalents and modifications will occur to others skilled in the art upon the reading and understanding of the specification. It is envisioned that after reading and understanding the present inventions those skilled in the art may envision other processing states, events, and processing steps to further the objectives of the system of the present inventions. The present inventions include all such equivalents and modifications, and is limited only by the scope of the following claims.

1. An improved machine learning method comprising:
creating a first machine learning model with training data;
periodically adjusting the first machine learning model with production data to create a second machine learning model;
creating a training dataset by processing the training data through the first machine learning model;
creating a prediction dataset by processing the production data set through the second machine learning model; and
looping through each feature in the prediction dataset:
determining a p-value by comparing the feature in the prediction dataset to the feature in the training dataset; and
if the p-value is less than a constant and a confidence interval for the training dataset does not overlap the confidence interval for the prediction dataset, creating an alert.

2. The improved machine learning method of claim 1 further comprising performing a T-test to determine the p-value.

3. The improved machine learning method of claim 1 further comprising performing a binomial proportions test to determine the p-value.

4. The improved machine learning method of claim 1 further comprising automatically adjusting the first machine learning model based on the alert.

5. The improved machine learning method of claim 1 further comprising automatically adjusting the second machine learning model based on the alert.

6. The improved machine learning method of claim 1 further comprising creating a plot of the feature in the prediction dataset.

7. The improved machine learning method of claim 1 wherein the first machine learning model is created using a Densicube algorithm.

8. The improved machine learning method of claim 1 wherein the first machine learning model is created using a K-means algorithm.

9. The improved machine learning method of claim 1 wherein the first machine learning model is created using a Random Forest algorithm.

10. The improved machine learning method of claim 1 wherein the overlap in the confidence interval uses a mean and a margin of error.

11. A method for creating machine learning model performance alerts comprising:
creating a first machine learning model with training data;
adjusting the first machine learning model with production data to create a second machine learning model;
creating a training dataset by processing the training data through the first machine learning model;
creating a prediction dataset by processing the production data through the second machine learning model; and
looping through each feature in the prediction dataset:
determining a p-value by comparing the feature in the prediction dataset to the feature in the training dataset; and
if the p-value is less than a constant and a confidence interval for the training dataset does not overlap the confidence interval for the prediction dataset, creating the machine learning model performance alert.

12. The method of claim 11 further comprising if the feature is numeric, performing a T-test to determine the p-value.

13. The method of claim 11 further comprising if the feature is not numeric, performing a binomial proportions test to determine the p-value.

14. The method of claim 11 further comprising automatically adjusting the first machine learning model based on the machine learning model performance alert.

15. The method of claim 11 further comprising automatically adjusting the second machine learning model based on the machine learning model performance alert.

16. The method of claim 11 further comprising creating a plot of the feature in the prediction dataset.

17. The method of claim 11 wherein the first machine learning model is created using a Densicube algorithm.

18. The method of claim 11 wherein the first machine learning model is created using a K-means algorithm.

19. The method of claim 11 wherein the first machine learning model is created using a Random Forest algorithm.

20. The method of claim 11 wherein the overlap in the confidence interval uses a mean and a margin of error.
